(19) United States
(12) Patent Application Publication
(10) Pub. No.: US 2002/0032613 A1
(43) Pub. Date: Mar. 14, 2002

(54) Methods and systems for the physical delivery of goods ordered through an electronic network

(76) Inventors: Thomas H. Buettgenbach, San Diego, CA (US); Finbar Sheehy, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/836,455

(22) Filed: Apr. 16, 2001

Related U.S. Application Data
(60) Provisional application No. 60/197,499, filed on Apr. 18, 2000.

(51) Int. Cl. G06F 17/60

(52) U.S. Cl. 705/26

(57) ABSTRACT

The present system relates to systems and methods for providing delivery of goods purchased through electronic commerce. An embodiment of the present invention allows a user to purchase an item from a vendor or merchant in an e-commerce environment and have the item shipped to a selected Will-Call Center for pick up by a recipient. The recipient can be the user or some other designated party. The Will-Call Center further automatically notifies the recipient of the availability of the item to be picked up.

### RELATED APPLICATION

This application claims the benefit under 35 U.S.C. § 119(e) of U.S. Provisional Application No. 60/197,499, filed Apr. 18, 2000, the entirety of which is hereby incorporated by reference.

### BACKGROUND OF THE INVENTION

1. Field of the Invention

The present system generally relates to direct retailing, including both catalog retailing and electronic commerce. In particular, the present system relates to the delivery of goods ordered through an electronic network.

2. Description of the Related Art

In recent years, the growing accessibility to the Internet, one form of electronic network, has spurred the growth of electronic commerce (“e-commerce”). The Internet provides manufacturers and retailers with an economically efficient and easily accessed medium to present a catalog of their offerings to buyers. By contrast, the costs associated with traditional methods of printing and mailing catalogs is often prohibitive. Access to the Internet enables buyers to order products and services without the inconveniences of ordering, waiting for, and paying for printed catalogs, travelling to stores during open hours to see the products and/or place the orders, and the like.

A limitation of e-commerce and the Internet is the inability to ship tangible goods across an electronic medium. Most of the time, goods ordered in e-commerce are mailed or shipped to the buyer. Current systems for shipping and delivering products are often unsatisfactory. Home delivery is expensive, risky, and inconvenient. Buyers find it inconvenient to stay home to receive a package of the ordered good. Often, no one is at home to receive the package and the package may be left in a mailbox. Further, if the mailbox is not large enough to hold the package, the package may be left dangerously exposed in a public place such as a doorstep, or delivery of the package may be postponed and scheduled for re-delivery. Perishable products, such as food, are particularly susceptible to delays and delivery methods involving unsuitable forms of storage.

Some buyers address the concerns of home delivery by specifying delivery to their work site. However, employers may frown upon the use of company resources for personal use. Further, delivery at work is often incompatible with work resources because the product may be unsuitably large or heavy, and may be a perishable. Delivery to work is also disadvantageous when the buyer prefers to retain privacy and or anonymity with respect to ordered goods.

Buyers can also pick up a package at a hub operated by a courier, such as the “Hold for Pickup” service from the United Parcel Service® and the “Hold at FedEx” service from Federal Express. Disadvantageously, the hold services offered by couriers do not provide services such as automated notification of the arrival of packages and/or readiness for pick up, anonymous pick up, or refrigerated storage.

### SUMMARY OF THE INVENTION

The present will call system relates to devices and methods for providing delivery of goods purchased through direct retail, including electronic commerce. An embodiment of the present invention allows a user to purchase an item from a vendor or merchant in an e-commerce environment and have the item shipped to a selected Will-Call Center for pick up by a recipient. The recipient can be the user or some other designated party. The Will-Call Center further automatically notifies the recipient of the availability of the item to be picked up.

The vendor includes a machine-readable reference with the item to allow efficient identification of a package relating to the item. The machine-readable reference can include a common carrier's shipping label. Information relating to the machine-readable reference is stored in a database that is accessible by the Will-Call Center to identify the package when the package is received. Upon receipt of the item, the Will-Call Center relates the package to the recipient and automatically notifies the recipient of the availability of the item with an electronic message.

One embodiment communicates between the Will-Call Center and a computer associated with the recipient within a common firewall such as the firewall at a relatively large business site. One embodiment further allows a buyer or a recipient to change the selected Will-Call Center to a different Will-Call Center before, during, or after the item is shipped.

One embodiment further reserves space at the Will-Call Center for the arrival and the storage of the package. The vendor provides an estimate of a package size, and where applicable, a refrigeration requirement to the Will-Call Center. The Will-Call Center compares the storage requirements of the package to a database including an inventory of available physical spaces for at least the expected arrival date and/or time. Where adequate and appropriate storage space exists, the Will-Call Center indicates the presence of available space to the vendor, the vendor arranges for shipping to the Will-Call Center, and the Will-Call Center reserves an appropriate physical space for the package.

One embodiment according to the invention includes a process of selling an item in an e-commerce environment, receiving a designation for a Will-Call Center, and automatically communicating with the Will-Call Center to verify that the Will-Call Center has the capacity to store the item properly on the expected date of delivery to the Will-Call Center. Where the Will-Call Center has the capacity, the Will-Call Center is notified to reserve the space, and the item is shipped. When the item is ready to be picked up or when the item arrives at the Will-Call Center, the Will-Call Center automatically notifies the recipient of the availability of the item. Where the Will-Call Center lacks the capacity to receive the item, the vendor is notified and the vendor ships the item to another Will-Call Center or ships the item to arrive at the Will-Call Center on a different date. When the item is picked up, vendor automatically receives a message indicating the status of the pickup from the Will-Call Center.

One embodiment according to the present invention includes a process of making available an item purchased in e-commerce. The process advantageously makes the item available for pickup without requiring the assistance of an attendant, which can be of benefit during off-hours or for picking up private items. The process receives the item from a common carrier and automatically relates the item to the recipient through an id, such as a barcode label. The barcode label can be the same label used by a common carrier. The process stores the item in an electronically locked box and automatically sends a message to the recipient that the item is available to be picked up. An electronic key unlocks the box containing the item. The electronic key can be generated and sent to the recipient with an electronic message, or the electronic key can be received from the recipient. When the recipient arrives to pick up the item, the recipient enters a code. The code can be entered with a keypad, a barcode scanner, and the like. When the code matches with the electronic key, the recipient is provided access to retrieve the item.

One embodiment according to the present invention includes a process for quickly and efficiently shipping an item. The process can advantageously be used in the context of returning an item ordered from a vendor in e-commerce. The process includes providing a tillable form on a Web site that allows a user with a browser to enter appropriate shipping information from a remote computer in a wide area network. The shipping information is stored in a database and related to an at least temporarily unique id in the database. Preferably, the user writes the id on the package. When the package arrives for shipping, information relating to the package and the shipping are readily recalled from the database. In addition, a shipping label for a common carrier can be automatically printed from the database. When the package is picked up by the common carrier, the sender of the package is automatically notified of the pickup.

One embodiment according to the present invention includes an electronically lockable storage box for storing and delivering the item ordered through e-commerce. The box includes a movable access panel that locks in a first position to prevent unauthorized access to the interior of the box. Upon receipt of an unlocking key, the box provides access to the interior, thereby allowing a recipient to pick up the package. The unlocking key can be provided to the recipient in a message such as an email message or on a Web page, or can be provided by the recipient and stored in a database in communication with the lockable storage box.

One embodiment according to the present invention includes a Will-Call Center with a public area and a personnel area, where the public area includes access to electronically locked boxes and at least one computer terminal, as well as access to a customer counter from which a recipient can retrieve a delivery. Preferably, the Will-Call Center includes a transparent, semi-transparent, or translucent wall to display at least a portion of the stored deliveries.

### BRIEF DESCRIPTION OF THE DRAWINGS

These and other features of the invention will now be described with reference to the drawings summarized below. These drawings and the associated description are provided to illustrate preferred embodiments of the invention, and are not intended to limit the scope of the invention.

FIG. 1 illustrates an overview of a method and a system for the physical delivery of goods ordered through an electronic network.

FIG. 2 consists of FIGS. 2A and 2B and illustrates an exemplary overview system diagram of a delivery system.

FIG. 3 consists of FIGS. 3A and 3B and illustrates another embodiment of a delivery system.

FIG. 4 illustrates a process of providing a Web page tailored to a buyer.

FIG. 5 illustrates an embodiment of a delivery system in an Internet environment.

FIG. 6 illustrates an exemplary sequence of displays for a delivery rerouting system.

FIG. 7 illustrates a process according to one embodiment of the present invention of returning an item through a Will-Call Center.

FIG. 8 illustrates a process of rapidly preparing an item for a return to a vendor.

FIG. 9 illustrates one embodiment of a Will-Call Center that provides the physical delivery of goods.

FIG. 10 illustrates a layout of one embodiment according to the present invention.

### DETAILED DESCRIPTION OF PREFERRED EMBODIMENTS OF THE INVENTION

Although this invention will be described in terms of certain preferred embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

The present system addresses the disadvantages of home delivery and work delivery by advantageously providing buyers with methods and systems enabling the buyer to specify delivery of goods to a convenient intermediate “Will-Call Center.” The Will-Call Center accepts the goods for the buyer and allows the buyer to retrieve the goods from the Will-Call Center at a convenient time.

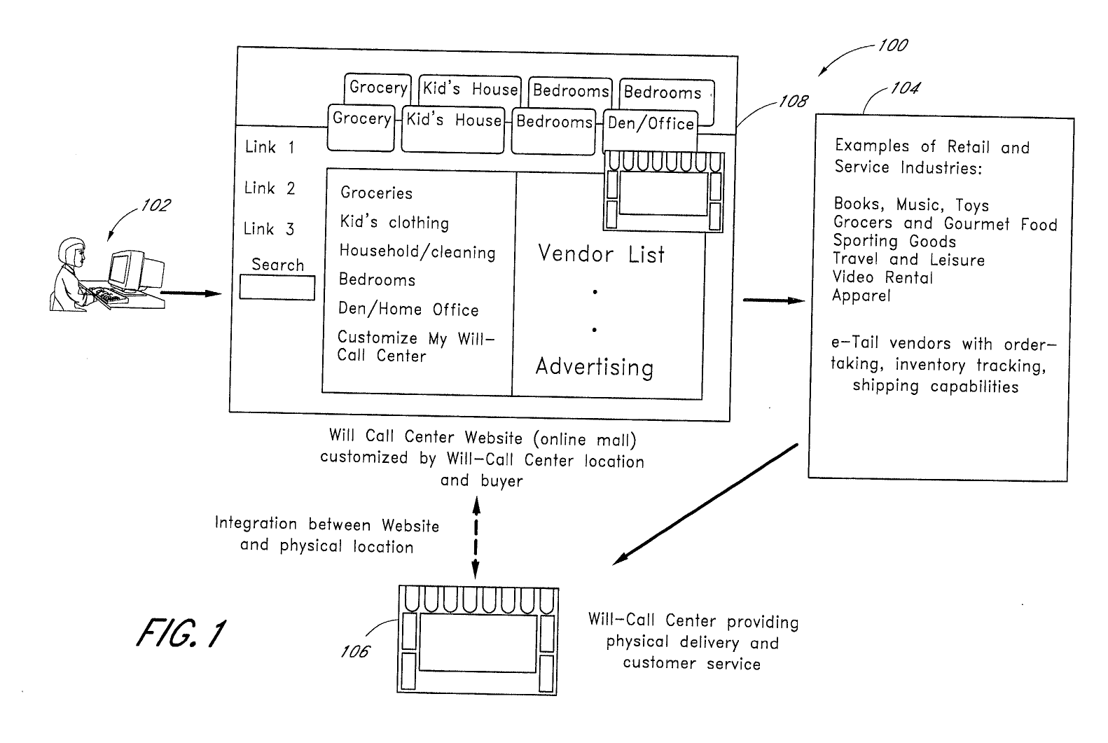

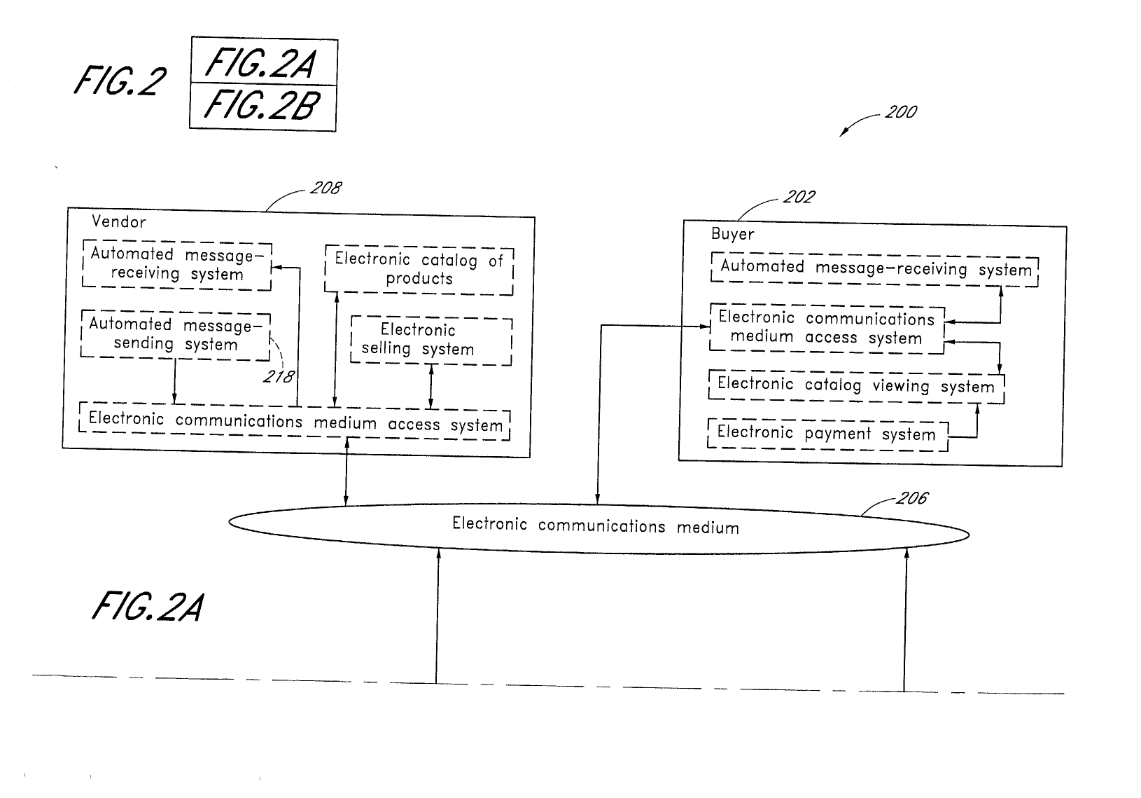

FIG. 1 illustrates one embodiment of a method and system 100 for the physical delivery of goods ordered through an electronic network such as the Internet. The system 100 includes the introduction of “Will-Call Centers” or Pick Up Centers in relatively high-traffic locations such as employment sites, apartment buildings, universities, gated communities, and retail locations. A buyer with a client computer 102 orders a product online from an online merchant or vendor 104. The vendor 104 may be independent or may be affiliated with a Will-Call Center 106. The ordered product (“delivery”) is shipped to the Will-Call Center 106 by a common carrier or by the vendor and securely stored until picked up by the buyer 102 or by a person or service designated to pick up the delivery (“recipient”).

Will-Call Centers may vary considerably with respect to storage attributes. For example, some Will-Call Centers may be equipped to handle bulky goods. Other Will-Call Centers offer increased security for expensive products, refrigerated storage for perishables, etc. Some Will-Call Centers can handle legally controlled substances such as pharmaceutical drugs, tobacco products, and alcohol. Some Will-Call Centers may carry larger amounts of insurance than others to handle high value goods.

In one embodiment, the Will-Call Center 106 is associated with a number of vendors. At the buyer's request, a vendor from the group of vendors delivers a product to the buyer through the Will-Call Center 106. In one embodiment, the vendor designates delivery to a select Will-Call Center. For example, the vendor may choose to deliver through a particular Will-Call Center, a group of Will-Call Centers, or all Will-Call Centers.

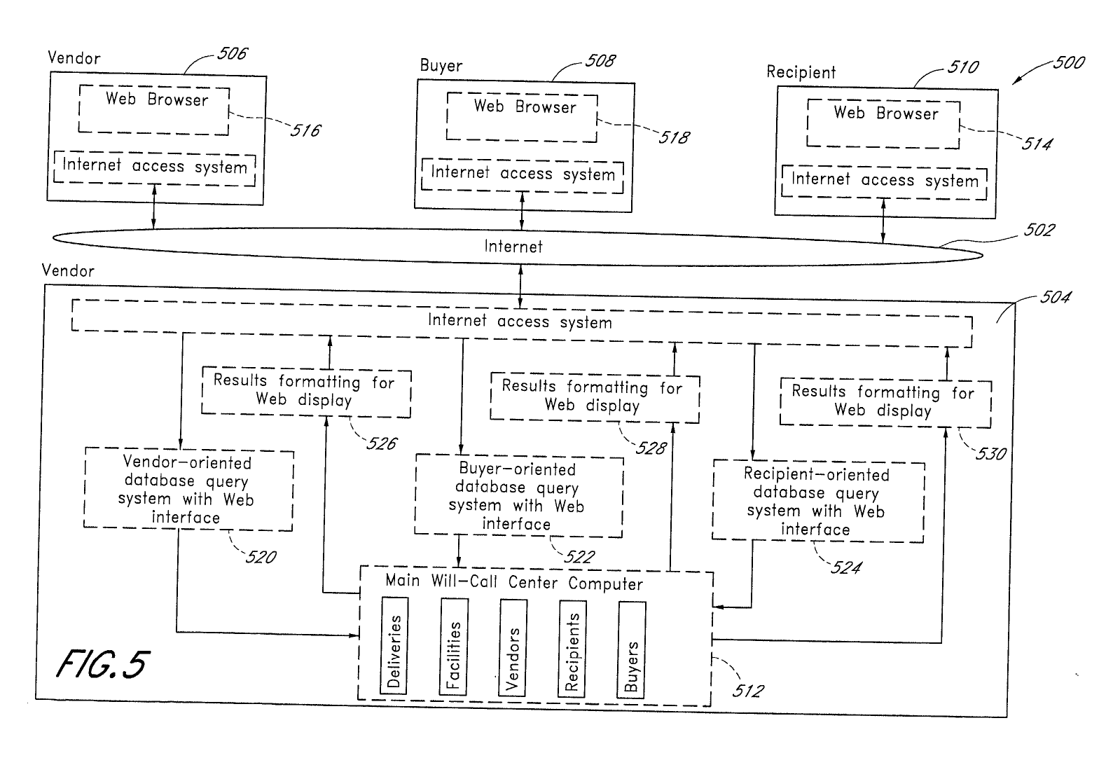

In the illustrated embodiment, the Will-Call Center 106 provides the buyer with a catalog of vendors 108 that includes the vendors whose products are available for delivery at the Will-Call Center 106. The catalog may be stored in a computer readable medium such as a disk drive and accessed by the client computer 102 through an electronic communications medium such as the Internet. A delivery system that provides communication through the Internet is also described later in connection with FIG. 5. In one embodiment, the catalog conforms to Web pages that are served from a computer system associated with the Will-Call Center 106 to the client computer system 102. The catalog allows a buyer to identify which vendors offer delivery through a particular Will-Call Center. The catalog of vendors may further include electronic links, i.e., hypertext links or hyperlinks, which allow a buyer to conveniently access a particular vendor for the Will-Call Center by selecting a corresponding electronic link.

In one embodiment, the Will-Call Center 106 manages the transaction between the customer and the vendor in a manner similar to a retail store, i.e., the Will-Call Center 106 receives payment from the buyer for the vendor. In another embodiment, the Will-Call Center does not handle cash or other financial transactions from the buyer. Rather, the buyer and the vendor transact with each other without intervention from the Will-Call Center. Instead, the Will-Call Center provides a service to buyers and vendors. In one embodiment, the Will-Call Center is unlike a retail store and does not collect payment from the recipient upon delivery. The Will-Call Center may collect service fees from the buyer for special deliveries, rerouted deliveries, late pickup, non-partner-vendor purchases or any other service fees.

Products to be delivered through the Will-Call Center are shipped to the Will-Call Center using standard logistics methods such as mail, common carriers, couriers, and other logistics/shipping systems including the vendor's own logistics system.

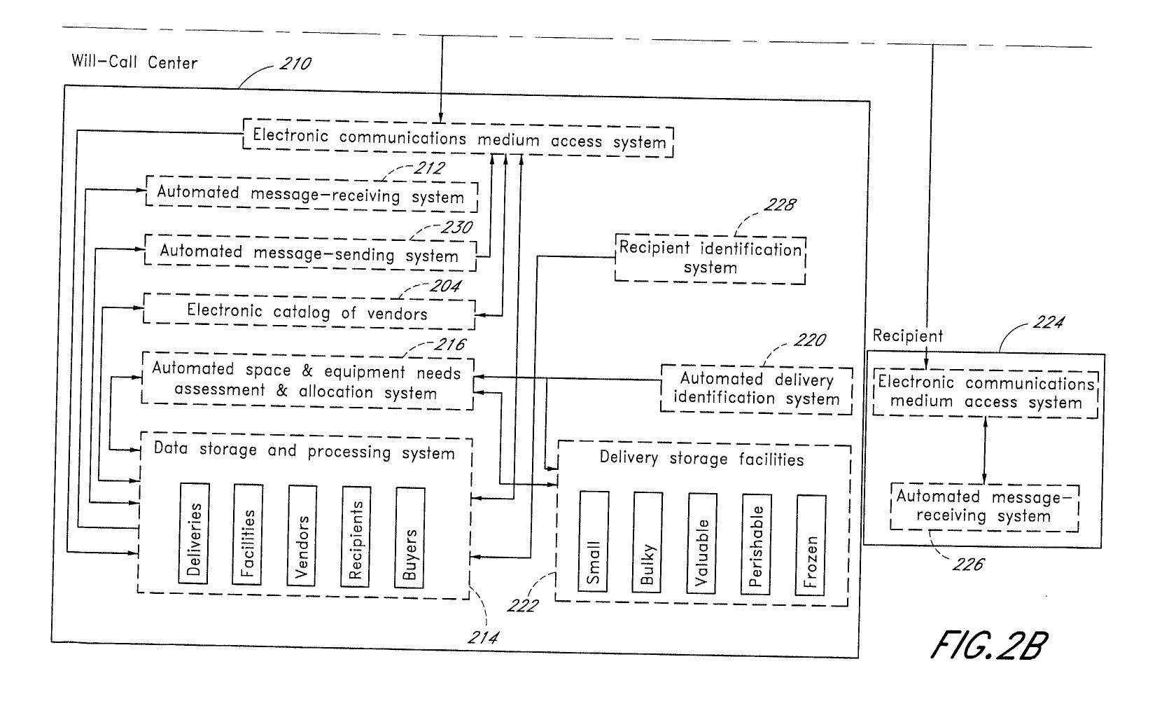

FIG. 2 illustrates an exemplary overview system diagram of a delivery system 200 according to one embodiment of the present invention. In FIG. 2, a buyer with a client computer 202 communicates with a Web site associated with a Will-Call Center 210 through an electronic communications medium 206. In one exemplary sequence of events, the buyer uses a Web browser such as Microsoft® Internet Explorer or Netscape® Navigator to view an electronic catalog of vendors 204 accessible through the Will-Call Center's Web site. The buyer's Web browser accesses the Will-Call Center Web site through the electronic communications medium 206. The electronic communications medium 206 may comprise a corporate intranet, a private network, a wireless network, and public networks such as the Internet. The buyer 202 may access the Internet through, for example, an Internet Service Provider. The buyer 202 may also use traditional methods of communication such as by instructing another person or system to enter data into such as system, e.g., by ordering via phone or fax and having the vendor enter the data into a system that eventually communicates with the Will-Call Center's communication systems. By viewing the electronic catalog, the Will-Call Center Web site conveniently identifies the vendors that offer delivery of the desired product through the Will-Call Center.

Once a vendor 208 is selected, the buyer 202 orders a product from the vendor. The buyer 202 selects products from a vendor's electronic catalog of products, which is accessed through the electronic communications medium 206. In one embodiment, the vendor's electronic catalog of products is a Web site, the electronic communications medium 206 is the Internet, and the buyer 202 accesses the Web site with a Web browser. To specify how the product is to be delivered, the buyer 202 selects delivery through specifies a Will-Call Center 210 and identifies a recipient 224 and provides additional contact information for the recipient 224 as needed. The recipient 224 can include a designated person, a service, or even the buyer 202. Alternatively, the buyer 202 can use a Web interface to inform the Will-Call Center 210 of the identity and the contact information of a designated alternative recipient, so that either the buyer or the designated alternative recipient can pick up the product at the Will-Call Center 210. In one embodiment, the vendor 208 is unaware of the identify of the designated alternative recipient.

The buyer 202 pays the vendor using an Electronic Payment System that communicates with the vendor's electronic selling system through the electronic communications medium 206. In one embodiment, the buyer 202 enters credit-card information into a Web browser, which communicates this information to the vendor's credit-card payment processing system through a Secure Sockets Layer connection over the Internet or other secure technology data transfer connection.

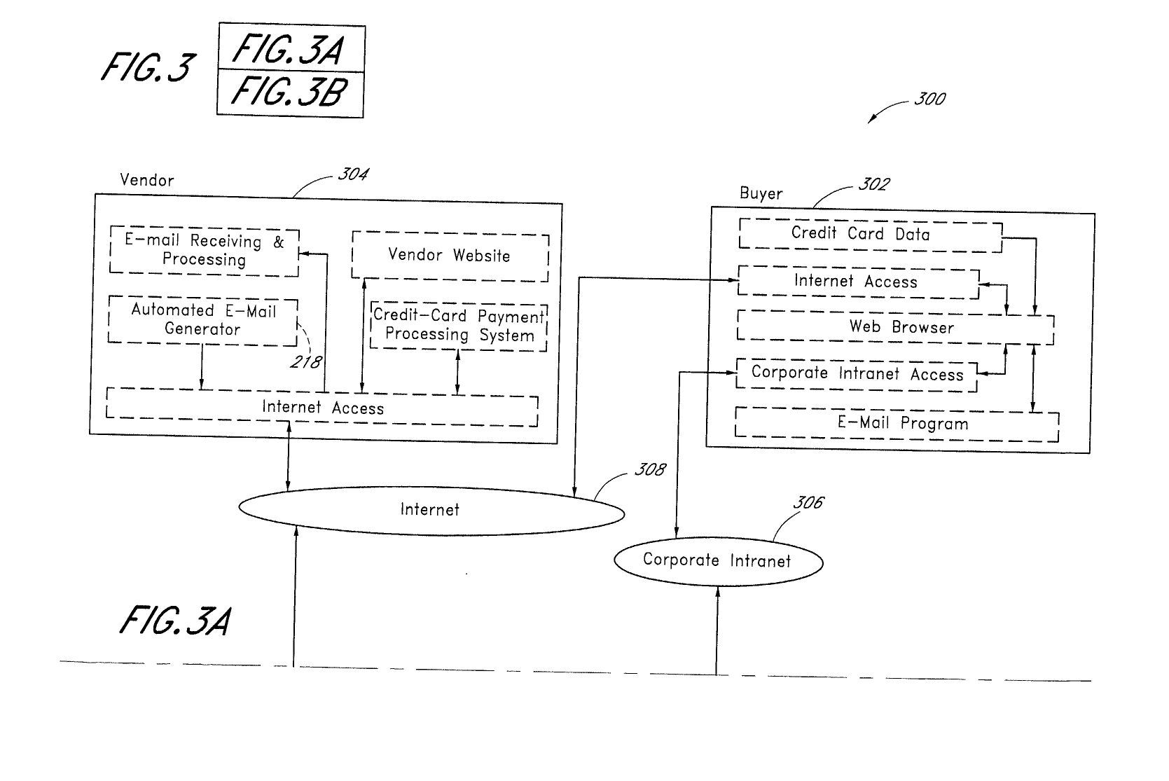

In one embodiment, the vendor 208 transmits an order notification message to the Will-Call Center 210 via an automated message sending system 218, which can include an automatic e-mail generator. The automated message system 218 can communicate with other systems with one or more of a variety of messaging types and standards such as e-mail, instant messaging, and XML. The contents of the order notification message include transactional details such as a quantity and an identifier of the ordered product, specification of delivery to the Will-Call Center 210, and identification and contact information for the buyer 202 and/or the recipient 224. The order notification message may further include information relating to a size and a storage requirement of the delivery. For example, the order notification message may indicate that the delivery requires refrigeration. The order notification is transmitted through the electronic communications medium 206 and is received by a Will-Call Center's automated message-receiving system 212, which can be an e-mail based receiving and processing system. The Will-Call Center 210, upon receipt of the order notification from the vendor's automatic e-mail generator, stores the information from the notification in its data storage and processing system 214, which is also depicted as a Main Will-Call Center computer 316 in FIG. 3.

The data storage and processing system 214 can be physically located at the Will-Call Center, but can also be distributed with some elements of the data storage and processing system 214 physically located at the Will-Call Center 210 and other elements of the data storage and processing system 214 physically located in one or more central locations also accessed by other Will-Call Centers. In one embodiment, the data storage and processing system 214 operates in accordance with an “Application Service Provider” (ASP) model and includes an on-site Web browser component and a central Web server component so that the central Web server component processes and stores data for most of the functions of the data storage and processing system 214.

Preferably, the Will-Call Center 210 forwards the information from the order notification message to an automated space and equipment needs assessment and allocation system software 216, which performs the following steps:

1. assessment of storage, such as space, refrigeration, security, and legal requirements to store the delivery properly on its arrival,

2. analysis of the storage required by the delivery as compared to the available storage in the Will-Call Center's storage facilities 222,

3. allocation and reservation of a suitable storage space for the delivery if there is adequate storage in the Will-Call Center's storage facilities 222, and

4. notification to the Will-Call Center's personnel to provide additional storage space or notification to the vendor 208 that the Will-Call Center 210 cannot accept the planned delivery if the Will-Call Center 210 lacks adequate storage for the planned delivery.

The vendor 208 processes the order and ships the order as a delivery to the Will-Call Center 210 using an appropriate shipping method. In one embodiment, the buyer 202 specifies the method of shipment to the Will-Call Center 210.

The vendor's automated message sending system 218 or automatic e-mail generator automatically notifies the buyer 202 and the Will-Call Center 210 that the order has been shipped and that delivery through the Will-Call Center 210 has been specified. In one embodiment, the vendor's automated message sending system 218 or automatic email generator notifies the buyer 202 and the Will-Call Center 210 with separate messages, i.e., the buyer 202 receives a first message and the Will-Call Center receives a second message. In another embodiment, the vendor's automated message sending system 218 sends a message to the Will-Call Center 210, which then sends a subsequent message to the buyer 202. A message may also be sent to the recipient 224, via either the vendor 208 or the Will-Call Center 210. In one embodiment, the messages to the buyer 202 and recipient 224 are e-mail messages. In other embodiments, the messages are automatically generated faxes, voicemail, or pages.

The Will-Call Center 210 receives and identifies the delivery with an automated delivery identification system 220. The automated delivery identification system 220 may identify or track the delivery with standard or proprietary barcode scanners and the related software. The automated delivery identification system 220 identifies the delivery and allows the Main Will-Call Center computer 214 to retrieve and to display the information relating to the space and equipment previously allocated or reserved for storage of the delivery. The data storage and processing software 214 records the arrival of the delivery at the Will-Call Center 210. A Will-Call Center attendant transports the delivery to the allocated space and equipment within the delivery storage facilities 222, where the delivery awaits pick up by the recipient 224.

The Will-Call Center's automated message sending system 212 automatically notifies the recipient 224 that the delivery is awaiting pick up at the Will-Call Center 210 by communicating with the recipient's Automated Message-Receiving System 226 through the electronic communications medium 206. Of course, the recipient 224 and the buyer 202 can be the same individual or entity. One form of automated message that can be used to notify the recipient 224 is an e-mail message. Other automated message types include voice synthesized voicemail, faxes, and paging. FIG. 3, which will be described later, illustrates an example where the Will-Call Center 210 notifies a recipient 224 by sending a text message to the recipient's text pager through a paging network.

In one embodiment, the Will-Call Center's automatic e-mail generator 230 also automatically notifies both the buyer 202 and the vendor 208, via e-mail messages, that the delivery is awaiting pick up at the Will-Call Center 210. This allows the buyer 202 and the vendor 208 to receive up-to-date information on the location of the delivery.

To pick up the delivery, the recipient 224 comes to the Will-Call Center 210 and provides identification that is applied to the Will-Call Center's recipient identification system 228 to validate the identity of the recipient 224. The recipient identification system 228 forwards the identity received to the data storage and processing system 214. The data storage and processing system 214 relates the recipient 224 with the deliveries that are present in the Will-Call Center 210 and designated for pick up by the recipient 224. In one embodiment, the data and processing system 214 relates multiple deliveries, such as all deliveries, that are designated for pick up by the recipient 224. The data storage and processing system 214 retrieves and displays information concerning the space and equipment where the deliveries are stored so that the deliveries can be efficiently retrieved from storage.

In one embodiment, the Will-Call Center 210 provides the recipient 224 with a barcoded keychain tag and identifies the recipient 224 by scanning the barcoded keychain tag. Other forms of identification include cards with magnetic strips, integrated circuit cards or “smart” cards, radio frequency ID cards, as well as manual methods.

Other forms of recipient identification system include identification through credit cards, specially-issued membership cards, employer ID badge numbers, driver's license numbers, social security numbers, phone numbers, thumbprints, recipient's vehicle license plate number, wireless identification devices, student IDs, and the like. In one embodiment, a relatively secure recipient identification system, such as a driver's license, employer-provided secure ID, or a retina scanning identification system, provides a relatively high degree of assurance that an identification provided by a recipient who picks up a delivery at the Will-Call Center 210 accurately identifies the recipient.

Following the pickup by the recipient 224, the data storage and processing system 214 records that the recipient 224 has picked up the deliveries. The recorded information preferably includes the date and the time of the pickup, as well as the identification used to identify the recipient 224. The data storage and processing system 214 updates the information in the automated space and equipment needs assessment and allocation software 216 to release the space previously allocated for the picked up deliveries for use by subsequent deliveries.

Following delivery, the Will-Call Center's automated message-sending system 230 preferably automatically notifies the buyer 202 and the vendor 208 that the delivery has been picked up by the recipient 224. The message can be, for example, an automatically generated e-mail message. The automatic notification preferably includes the time and the place of the pickup, and also includes at least a portion of the identification used by the recipient 224.

FIG. 3 illustrates another embodiment of a delivery system 300. The delivery system 300 illustrated in FIG. 3 is similar to the delivery system 200 illustrated in FIG. 2, but includes several modifications. The delivery system 300 also allows a buyer 302, a vendor 304, a Will-Call Center 310, and a recipient 312 to communicate. In contrast to the electronic communications medium 206 of FIG. 2, the buyer 302, the vendor 304, the Will-Call Center 310, and the recipient 312 communicate in the illustrated delivery system 300 of FIG. 3 through a corporate intranet 306, an Internet 308, and a paging network 314. The intranet 306 can be associated with other relatively large organizations such as universities.

The Will-Call Center 310 communicates with the buyer 302 through the Internet 308 or the intranet 306. The intranet 306 provides a convenient medium for a Will-Call Center 310 that, for example, is located on a campus of a relatively large entity such as a corporation or university to restrict access to a buyer 302 who is related to the entity. The intranet 306 can be used to allow the Will-Call Center 310 to promote different services, different pricing rates such as subsidized rates, and the like for employees as opposed to the general public. In one embodiment, the Will-Call Center 310 is located in a hospital or in a relatively large apartment complex such as an apartment complex with at least 100 units. Of course, the buyer 302 and the recipient 312 can be the same person or entity. The buyer 302 communicates with the vendor 304 through the Internet 308. Where the buyer 302 is a member of the general public, one embodiment allows the buyer 302 to communicate with the Will-Call Center 310 through the Internet 308.

The Will-Call Center 310 illustrated in FIG. 3 is similar to the Will-Call Center 210 illustrated in FIG. 2. The Will-Call Center 310 illustrated in FIG. 3 also includes storage facilities 318 and a Main Will-Call Center Computer 316, which is adapted to automatically receive information on future deliveries to the Will-Call Center, to automatically allocate space in the storage facilities 318 for the future deliveries, and to automatically notify the recipient 314 when the delivery is awaiting pickup. It will be understood by one of ordinary skill in the art that the delivery system 300 can further include automated interfaces to common carriers, such as to the UPS® and to the Federal Express. The interface to the common carriers allows the Will-Call Center Computer 316 to arrange for delivery from the vendor 304 and to receive updates on delivery dates. The vendor 304 can also arrange for delivery from the common carriers.

Other peripheral equipment in the Will-Call Center 310 includes a credit-card scanner 320, a barcode scanner 322, and an interface 324 to the paging network 314. One embodiment of the delivery system 300 uses the credit-card scanner 320 to authenticate the identity of the recipient 312. The barcode scanner 322 identifies a delivery by scanning a barcode label such as a shipping label or a custom label that applied to the package and relating the reference returned from the barcode label to the appropriate record in a database. Of course, a label can be included inside the package or kept in an envelope rather than applied to a package. The interface 324 to the pager network 314 allows the Main Will-Call Center Computer 316 to notify the recipient 312 that the delivery is ready to be picked up by sending a text based page to a pager 326. The interface 324 to the paging network 314 can be accomplished with a dial-up connection or through the Internet. The text pager 326 receives a radio frequency modulated signal from the paging network 314. In another embodiment, the text pager 326 is a wireless Internet device such as a Web-enabled cellular telephone or a wireless portable digital assistant.

The Main Will-Call Center Computer 316 can be physically located at the Will-Call Center 310, but can also be distributed with some elements of the Main Will-Call Center Computer 316 physically located at the Will-Call Center 310 and other elements of the Main Will-Call Center Computer 316 physically located in one or more central locations that are networked with other Will-Call Centers. In one embodiment, the Main Will-Call Center Computer 316 operates in accordance with an “Application Service Provider” (ASP) model and includes an on-site Web browser component and a central Web server component so that the central Web server component processes and stores data for most of the functions of the Main Will-Call Center Computer 316.

In one embodiment, a Will-Call Center is sponsored by a relatively large employer. Preferably, the sponsored Will-Call Center is in relatively close proximity to a large pool of employees who work for a single employer. In one embodiment, the sponsored Will-Call Center is located in a building with the large pool of employees. The employer hosts the sponsored Will-Call Center at its location, which it may own, rent or lease, and the sponsored Will-Call Center primarily delivers products to the employees who work at that location. The employer-specific Will-Call Center Web site preferably limits delivery to a group of employees, consultants, contractors and other stakeholders.

In one embodiment, the employer-specific Will-Call Web site is accessible through the employer's own electronic network, such as an intranet. In one embodiment, the employer-specific Will-Call Web site may be accessed through a public network such as the Internet with password-protected access to limit access to employees, consultants, contractors and other users authorized by the employer. For non-employees who wish to target deliveries through the Will-Call Center, a publicly accessible Will-Call Center Web site can optionally be provided. The public Will-Call Center Web site may be accessed by the general public without a password. The employer-specific Will-Call Web site may optionally differ from the public Will-Call Center Web site enabling an employer to subsidize certain products for the employees and to offer other benefits to employees through the Web site. Employers may promote the Will-Call Center as a benefit to employees at the site. As such, the Will-Call Center is co-promoted to employees by the employer and by the Will-Call Center operator.

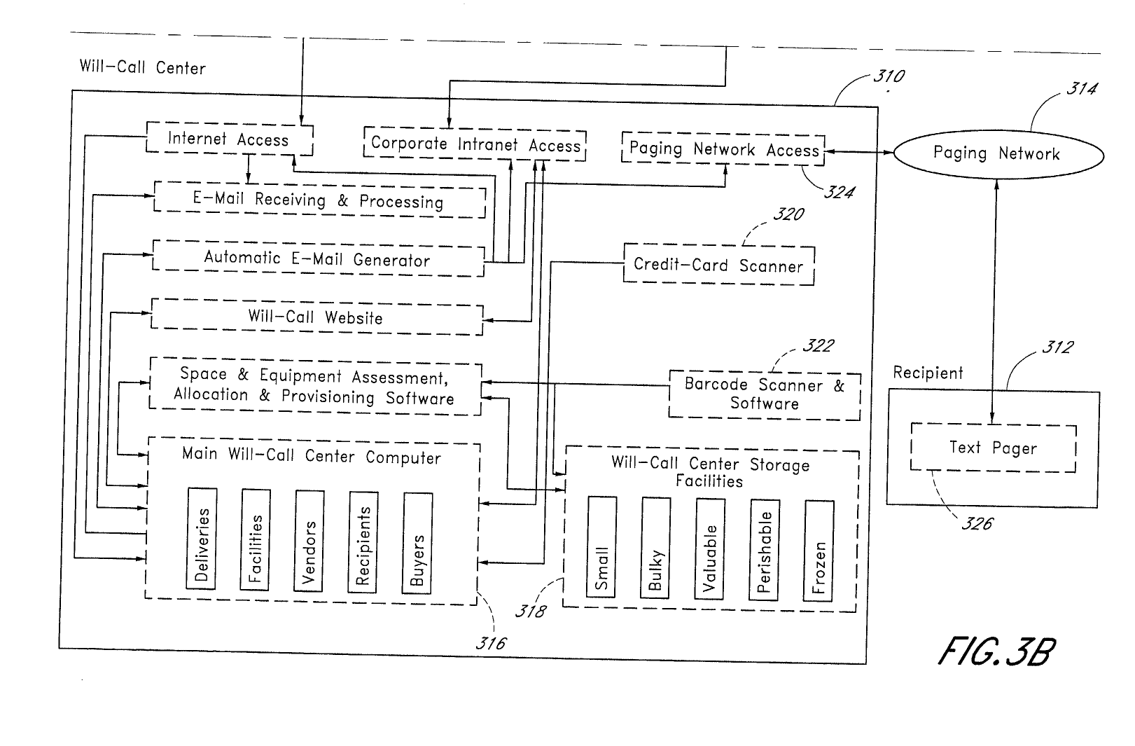

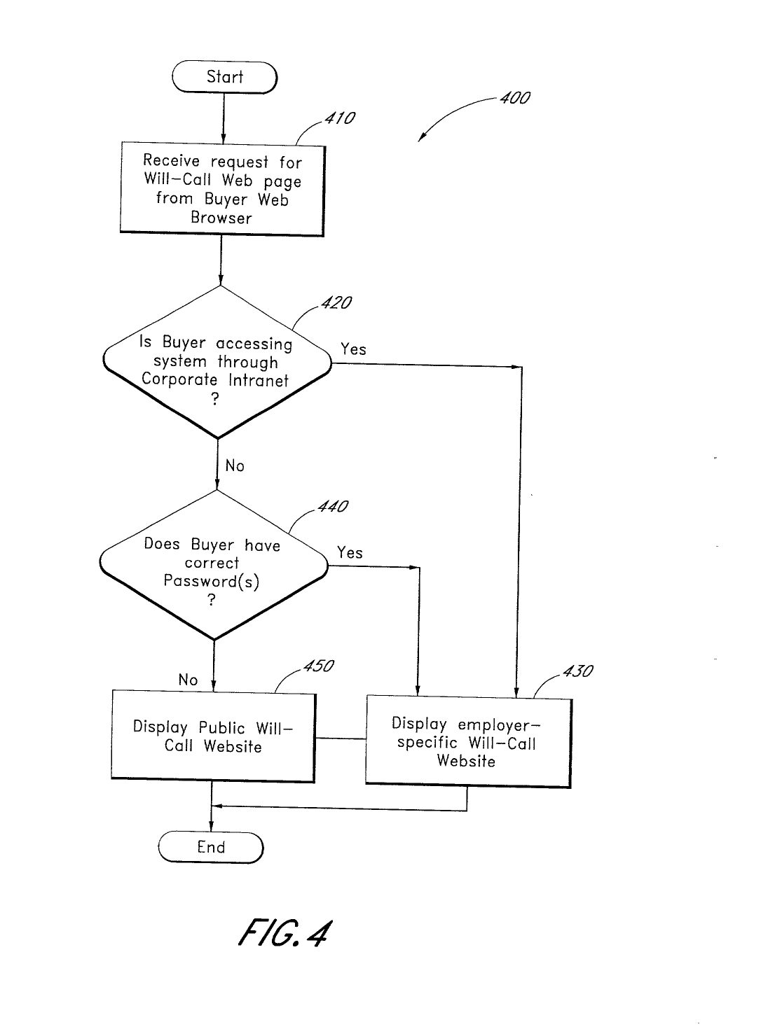

FIG. 4 illustrates a process of tailoring a Web page providing access to a sponsored Will-Call Center to a buyer. The Web page can be tailored to offer different pricing or services to a buyer who is an employee of the sponsoring organization, rather than a buyer who is merely a member of the general public.

In a first step 410, the Main Will-Call Center computer 316 receives a request for a Web page from the buyer 302. The process advances from the first step 410 to a first decision block 420.

In the first decision block 420, the process evaluates whether the buyer 302 is accessing the Main Will-Call Center computer 316 through the intranet 306, i.e., within an organization's firewall, or through the Internet 308. Where the access is through the intranet 306, the process proceeds from the first decision block 420 to a second step 430. Where the access is through the Internet 308, the process proceeds from the first decision block 420 to a second decision block 440.

In the second step 430, the process displays a Web page tailored to the sponsoring organization. The Web page can include discounted pricing schedules, varying delivery options, and the like.

In the second decision block 440, the process receives a userid and a password, and evaluates it for a match in an employee or membership database. Where the userid and the password match with the records in the database, the process proceeds from the second decision block 440 to the second step 430. Where the userid and the password fail to match with the results in the database, the process proceeds from the second decision block 440 to a third step 450.

In the third step 450, the process displays a Web page configured for the general public. This allows a buyer without intranet access to the Will-Call Center to nonetheless receive information from the sponsored Will-Call Center. The information can include alternative pricing schedules for those buyers that are not members of the sponsoring organization, alternative Will-Call Center sites, checking status, and the like.

In another embodiment, multiple entities including employers collectively share a Will-Call Center. Multiple employers are often in relatively close proximity to each other in office buildings. The Will-Call Center can feature multiple Web sites where a Web site may be customized in the manner previously described for an employer which shares the Will-Call Center. The Will-Call Center may further feature a publicly accessible Web site to provide service to the general population.

In another embodiment, a Will-Call Center includes at least one electronically lockable storage box. The Will-Call Center stores the delivery in the box. The box includes a keypad or other device that allows the recipient to unlock and to open an access panel of the box, and to pick up the delivery. One advantage of the box is flexible availability. The contents of the box may be accessible to the recipient without the assistance of a Will-Call Center attendant present or may be accessible during off-hours. In one embodiment, a computer from the Will-Call Center sends a message to the recipient containing a key, which will open the box. The box can be opened by opening a door, a lid, a sliding drawer, and the like. In another embodiment, the recipient sends a message containing the key to the Will-Call Center computer, which programs the box accordingly. Naturally, the box may also be used by the buyer for returning as well as retrieving deliveries.

In another embodiment, a Will-Call Center allows for selection of the Will-Call Center by postal zip code. For example, a Web page may feature searching for Will-Call Centers by postal zip code. In another example, the vendor's software may suggest a Will-Call Center location by searching for locations near a buyer or a recipient. For added convenience, a postal zip code and an extension may identify a specific Will-Call Center. The zip code and extension are related to an address in a database, and the system automatically generates a shipping address from the database.

There are many suitable locations for a Will-Call Center. For example, a Will-Call Center can be hosted by a contract provider of managed services at the employment site. The provider of services may host and operate the Will-Call Center independently or jointly with the employer. Examples of other appropriate services at a work site include foodservice providers with cafeterias, contract mailroom service providers, and contract copy service providers. A Will-Call Center may be located in a shopping mall optionally in conjunction with other retail stores and services such as convenience stores, dry cleaners, and gas stations. Naturally, a variety of goods and services may be offered at a Will-Call Center because a variety of goods are available over the Internet. Examples of goods and services available for purchase over the Internet at a Will-Call Center include books, clothing, computers, electronic equipment, groceries, household supplies, postage stamps, document printing such as checks, dispute resolution between parties such as vendors, buyers, recipients, and common carriers, and quality checks of the condition of deliveries upon arrival. Other convenient locations for Will-Call Centers include apartment buildings, gated communities, and universities.

FIG. 5 illustrates an embodiment of a delivery system 500, including Internet components. The delivery system 500 described in connection with FIG. 5 is similar to the delivery systems 200, 300 described in connection with FIGS. 2 and 3. The delivery system 500 includes an Internet 502, which allows the components of the delivery system 500 to communicate with each other. The delivery system 500 further includes a Will-Call Center 504, a vendor 506, a buyer 508, and a recipient 510. It will be understood by one of ordinary skill in the art that the delivery system 500 can further include automated interfaces to common carriers, such as to the UPS® and to the Federal Express.

The Will-Call Center 504 includes a Main Will-Call Center Computer 512 with database components. The vendor 506, the buyer 508, and the recipient 510 access the Main Will-Call Center Computer 512 with Web browsers 516, 518, 514, through the Internet 502, and through applications allowing database query 520, 522, 524. In one embodiment, results of requests for information or action are returned to the vendor 506, the buyer 508, and the recipient 510 through Web pages created by formatting blocks 526, 528, 530. The formatting blocks 526, 528, 530 can be implemented by the Main Will-Call Center Computer 512 with application program interfaces (APIs). Of course, other formats other than Web pages can be used to access information from the Main Will-Call Center Computer 512.

In one embodiment, the buyer 508 and the recipient 510 are the same individual or entity. In addition, it will be understood by one of ordinary skill in the art that the buyer 508 can use one computer system to place an order, and the buyer 508 or the recipient 510 can use another computer system to retrieve delivery information.

One embodiment further advantageously mitigates against identity theft, the resulting fraud from identify theft, and casual theft. For example, rather than leaving a delivery in a remote location where the delivery can be easily retrieved by a thief or an impersonator, the Will-Call Center can verify and store the identify of the buyer, the recipient, or the courier service that picks up the delivery. Where the identity provided is suspicious, the Will-Call Center can take further corrective action by notifying the credit card company of the suspicious activity. In addition, relatively highly-secure recipient identification systems can be used to provide a relatively high degree of assurance that the buyer, the recipient, or the courier service recorded as having received a delivery is actually the person who received the delivery.

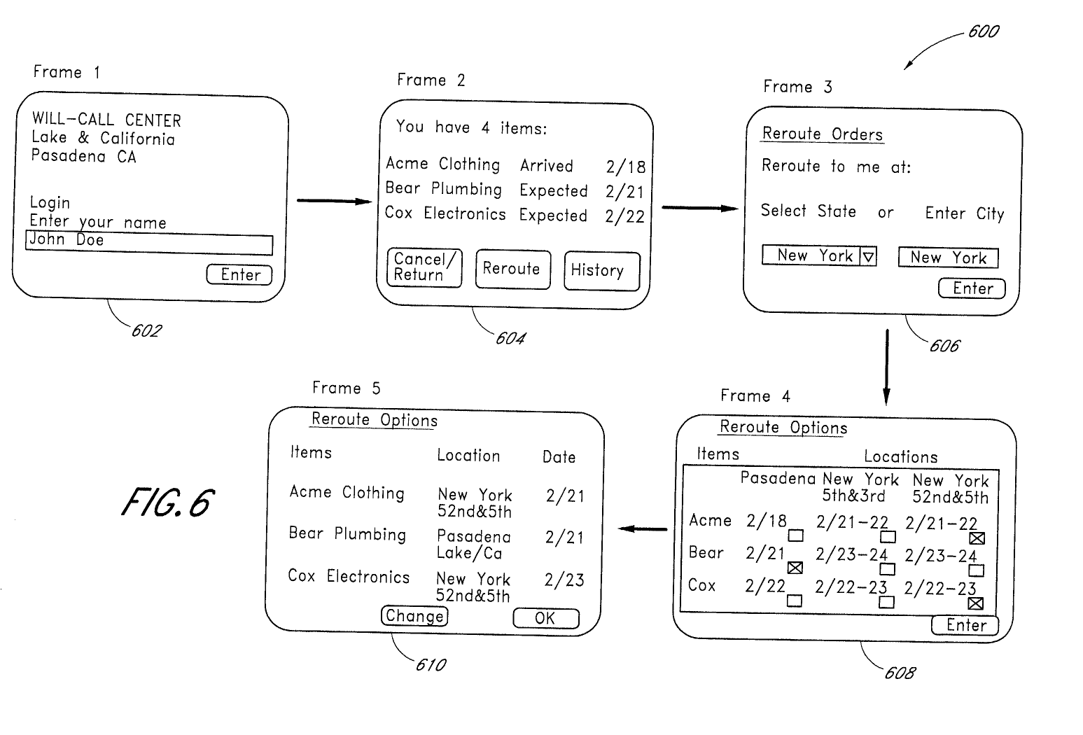

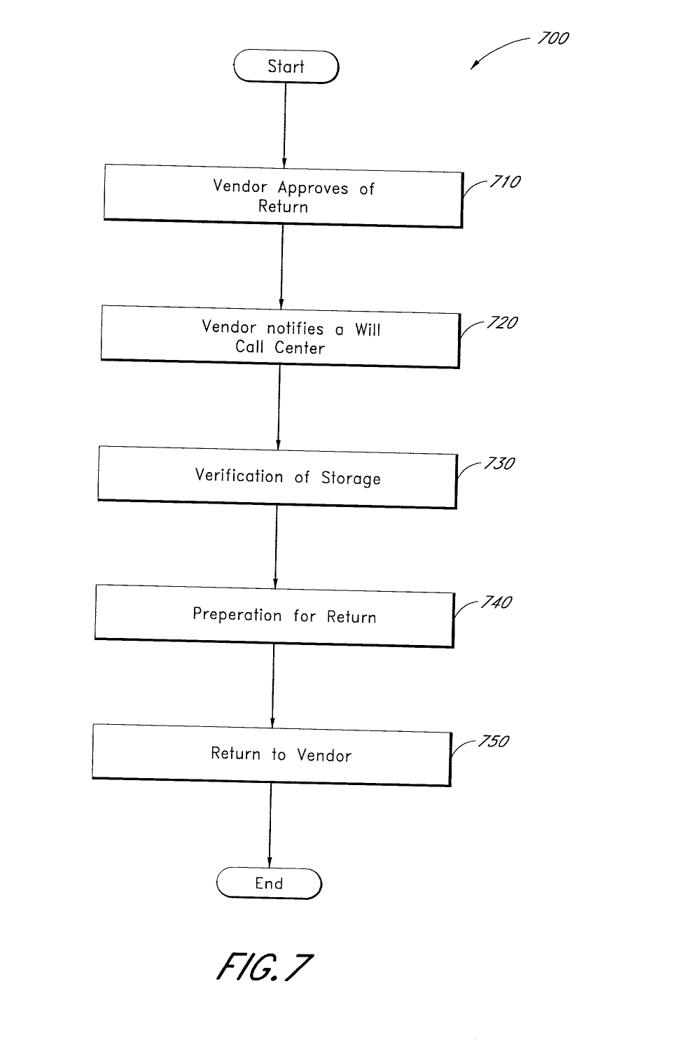

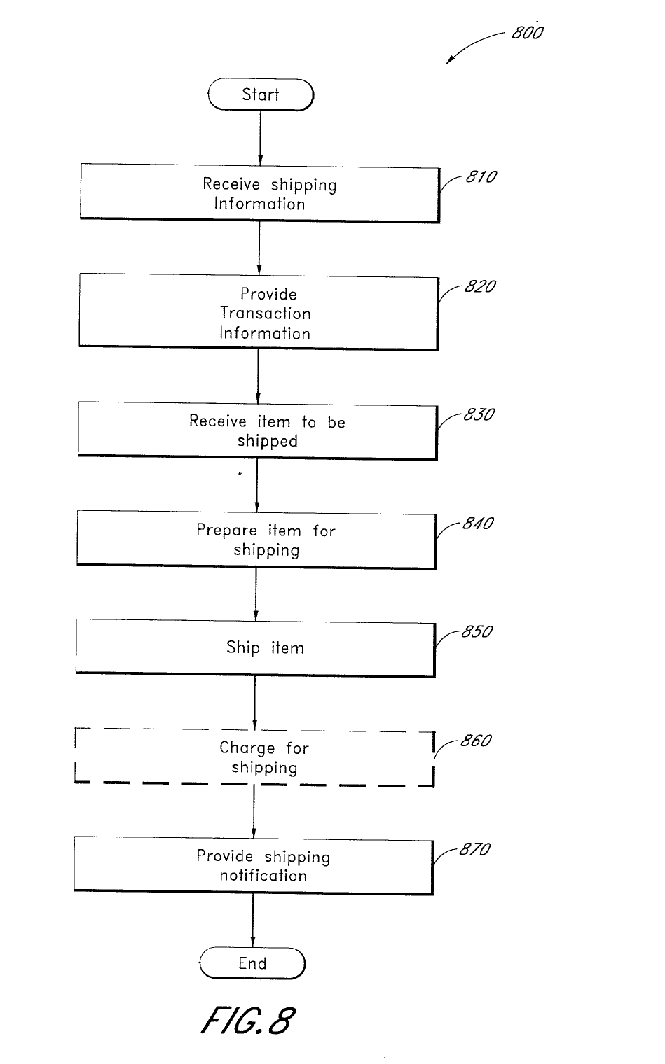

FIG. 6 is described after a description of FIG. 7.

FIG. 7 is a flowchart 700 illustrating one embodiment of a method to receive a return through a Will-Call Center. As is well known, goods that are purchased are often later returned. A vendor may advantageously contract with a Will-Call Center to process a portion of the return.

In an optional first step 710, a buyer contacts the vendor and requests authorization for the return. It will be understood by one of ordinary skill in the art that a return policy embedded in the purchase agreement from the vendor can implicitly authorize the return. As is common, the vendor and the buyer often negotiate on terms. In the example shown, the vendor approves of the return and communicates with a Will-Call Center that will physically accept the return.

In a second step 720, the vendor notifies a selected Will-Call Center so that the Will-Call Center can expect the arrival of the return. In another embodiment, the vendor first communicates with a Will-Call Center and verifies that the Will-Call Center can accommodate the return. In yet another embodiment, the vendor communicates with a series of Will-Call Center or a central computer for a group of Will-Call Centers and selects a Will-Call Center based upon a variety of factors including location, availability of appropriate storage space, and buyer preference. It will also be understood by one of ordinary skill in the art that no explicit notification may be necessary where a return is pre-authorized. For example, where the vendor does not require or receive explicit authorization, the vendor does not provide notification to the Will-Call Center. In another embodiment, the buyer, or another party returning the item, notifies the Will-Call Center of the return.

The notification from the vendor, the buyer, or the returning party may include, for example, an identity of the buyer, the recipient, or a courier service that will bring the return to the Will-Call Center. The communication may also include details about the return such as information on the size, the storage, and the packaging requirements for the return, and a day and time to expect the return. This notification, where provided by the vendor, is preferably created automatically by the vendor's automatic e-mail generator and is transmitted to the Will-Call Center's e-mail receiving and processing system through the Internet, following an action by the vendor's customer-service personnel and customer-service software. Where provided by the buyer or returning party, the notification is preferably created by electronic communication with the Will-Call Center. The selected Will-Call Center, on receipt of the return notification, stores the information from the notification in a computer such as the Main Will-Call Center computer.

In a third step 730, the Main Will-Call Center computer provides the information from the return notification to an automated space and equipment needs assessment and allocation software to assess and allocate space for the return. An example of functions that the automated space and equipment needs assessment and allocation software may perform include the following: (1) assessment of the space and equipment required to store the return properly on its arrival until it ships to the vendor, (2) comparison of the space and equipment required to accommodate the return with the available space and equipment in the Will-Call Center's storage facilities, (3) if there is adequate space and equipment in the Will-Call Center Storage Facilities, allocation of the space and equipment for storage of the delivery and stores that allocation information to ensure that the allocated space and equipment is reserved for the return, further, (4) if there is not adequate space and equipment in the storage facilities, the automated space and equipment software may notify the Will-Call Center's management that it needs additional space and/or equipment so that these can be provisioned, or may notify the vendor such that the vendor may select another Will-Call Center, or may notify the buyer and vendor to select a different time/day to receive the return, where the storage facility can accommodate the return on the different time/day, (5) initiation of the process of provisioning a shipping method to transport the return under appropriate shipping conditions to the vendor, and (6) initiation of the process of provisioning suitable packaging materials for the return.

In a fourth step 740, the buyer, the recipient, or the courier service brings the return to the Will-Call Center and the Will-Call Center prepares for the eventual return of the return to the vendor. In one embodiment, the Will-Call Center relates the allocated space and the return to an identification such as a credit-card, an employer identification badge or a driver's license. Thus, when the return arrives at the Will-Call Center, the buyer, the recipient, the courier service, or an attendant at the Will-Call Center can reference the appropriate file or record in a database. In an alternative embodiment, the Will-Call Center uses a barcode scanner to scan in the tag that was previously used for shipping the delivery to the recipient.

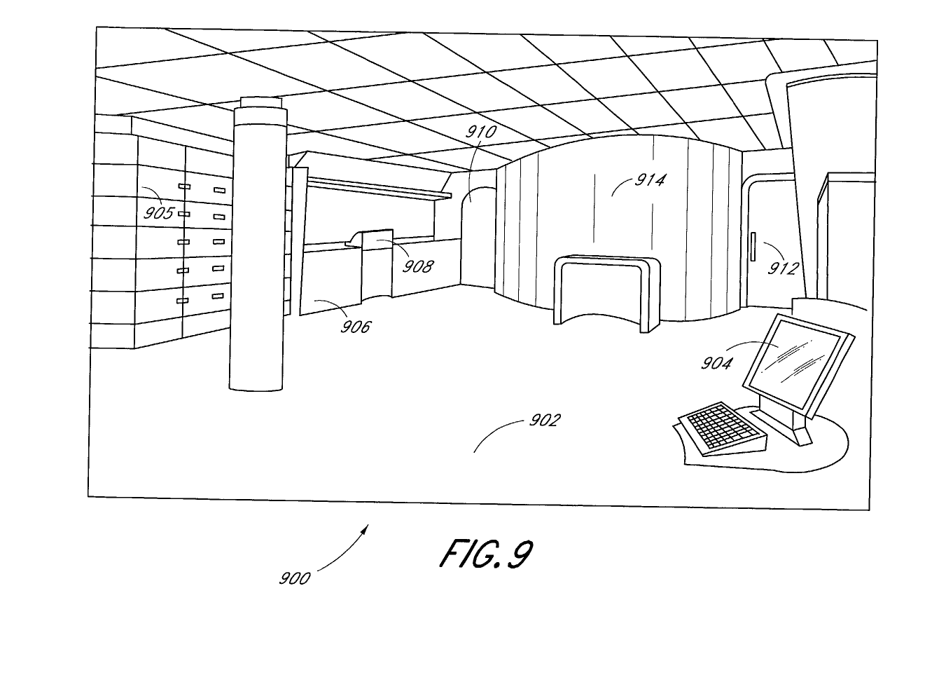

After the appropriate files and records are located, the software may optionally provide the attendant with inspection instructions and a procedure to follow in the event that the return fails to pass inspection. The inspection instructions from the vendor can indicate whether to inspect and levels of inspection. For example, the Will-Call Center may be instructed to identify that the returned contents match with expected contents and that the contents are undamaged. In an embodiment where the Will-Call Center receives the return in an off-hours box, such as the electronically locked box, the Will-Call Center may identify the return by reference to the electronically locked box and inspect the contents at a later time. The electronic key methods previously described may also be used to identify the box and the contents for return. In another embodiment, a package id described later in connection with FIG. 8 identifies the return.

If inspection is required, and the result of the inspection is favorable, the Will-Call Center accepts the return and makes an entry in the Main Will-Call Center Computer to confirm that the return has been accepted and stored. The Automated Space and Equipment Needs Assessment and Allocation Software identifies the packaging method, the storage requirements and the space and equipment allocated for storage of the product until shipped, and arranges shipping to transport the return back to the vendor.

In a fifth step 750, the Will-Call Center packages the return for shipping, stores the return using the allocated space and equipment, and the Will-Call Center arranges for the return to be shipped to the place specified by the vendor.

Preferably, the Will-Call Center's automatic e-mail generator notifies the vendor that the return has been accepted at the Will-Call Center and is ready to be shipped. Notification enables the vendor to initiate other steps it has agreed to with the buyer, such as refunding the price of the product without waiting for the product to be shipped back to the vendor's location. In one embodiment, the Will-Call Center notifies the vendor by sending an e-mail notification to the vendor's e-mail receiving and processing system.

At a point prior to shipping, the Will-Call Center preferably attaches a barcode label or other automatically readable instrument to the return to enable the vendor to easily identify the return. In one embodiment, the tag is common with the tag used by the common carrier to track packages within the common carrier's system. In another embodiment, the tag previously used for shipping to the buyer is retained. After the return has been shipped out of the Will-Call Center, a computer from the Will-Call Center, preferably the Main Will-Call Center computer, records that the return has been shipped to the vendor. The Main Will-Call Center records the date and time of shipment, the shipping method in use, and any shipment tracking information.

In one embodiment, the Will-Call Center's automatic e-mail generator notifies the vendor that the return has been shipped. One method for automatic notification is again to automatically send an e-mail message to the vendor's e-mail receiving and processing system. The notification includes information on the date and time of shipment, the shipping method in use, and shipment tracking information. In one embodiment, the common carrier notifies the vendor so that the vendor can expect delivery. After the return has been pulled from its allocated space, the Main Will-Call Center computer notifies the automated space and equipment needs assessment and allocation software to release the space and equipment previously allocated to the return.

A computer such as the Main Will-Call Center computer automatically calculates the applicable service charges for performing the handling service for the return in accordance with the agreement with the vendor or in accordance with an agreement with the buyer or returning party. The computer also automatically notifies the payer, which can be the vendor, the buyer or the returning party, as appropriate, of the amount of the service charge by using, for example, the automatic e-mail generator to send an e-mail message to the payer's e-mail receiving and processing system. In an alternate embodiment, a vendor calculates the fees in accordance with the agreement and notifies the Will-Call Center by using, for example, a similar automatic e-mail generator to send an e-mail message to a Will-Call Center computer. In yet other embodiments, the vendor and the Will-Call Center may propose and negotiate rates within the bounds of the agreement according to variables such as exigencies, degrees of damage, and difficulty of quality measurement.

In one embodiment, the Will-Call Center further provides status information to vendors and/or buyers. The information can be made available under a number of circumstances such as in response to a specific request made through a Will-Call Web site, an automatic transmission to designated parties on a regular schedule via e-mail, and an automatic transmission to designated parties via designated electronic communications medium in response to specific conditions. For example, the information can be available through a combined messaging system using desktop e-mail, text pager and/or synthetic voice messaging to a mobile phone based on a change in status of a delivery or return. Using the status reporting system, a vendor can advantageously query a computer such as the Main Will-Call Center computer to determine whether any products that the vendor shipped through the Will-Call Center are currently awaiting pickup at the Will-Call Center, whether any returns are expected at the Will-Call Center for that vendor, or whether there are returns for that vendor currently at the Will-Call Center awaiting shipment. The vendor can determine the time and date of pickup of deliveries that were delivered through the Will-Call Center in the past, as well as the identity of the recipient.

The vendor can determine the time and date, and the method of shipping of returns for that vendor, as well as any tracking information available to track the return during shipping. The vendor can determine the type of storage currently in use for any deliveries or returns at the Will-Call Center, as well as the types of storage used for deliveries and returns in the past.

Similarly, a buyer or a recipient can determine what deliveries may be awaiting pickup by the recipient at the Will-Call Center, as well as the type of storage being used to store those deliveries at the Will-Call Center. In addition, the buyer or the recipient can also conveniently determine expected arrival dates for multiple deliveries from multiple vendors by accessing a Web site associated with the specified Will-Call Center. The Will-Call Center 210 can report the status of multiple deliveries by relating the buyer's order and the shipping notifications received by the Will-Call Center from vendors. A Will-Call Center computer may further archive information to enable a buyer to retrieve information about the pickup by the recipient.

FIG. 6 illustrates an exemplary operation for a delivery rerouting system. Will-Call Centers may optionally include rerouting. At a time later than the initial transaction, the recipient 510 may decide to reroute the delivery to receive the delivery at a Will-Call Center location other than at a Will-Call Center originally specified. In another embodiment, the Will-Call Center 504 enables the recipient 510 to reroute the delivery within the Will-Call Center 504, e.g., to change from receiving the delivery from an attendant at the Will-Call Center 504 to receiving the delivery from an electronically locked box.

Upon receiving notification from the recipient 510 through, for example, a Web interface to the Main Will-Call Center computer 316, a delivery rerouting system determines whether the delivery can be rerouted as requested. A first frame 602, a second frame 604, a third frame 606, a fourth frame 608, and a fifth frame 610 illustrate an exemplary sequence of displays, which allow the recipient 510 to reroute the delivery. The displays are generated by the Main Will-Call Center computer 512 or a Web server associated with the Will-Call Center 504, transmitted through an electronic network such as the Internet 502, and displayed through the recipient's Web browser 514, to reroute a delivery.

The first frame 602 illustrates a sample display where a recipient uses the electronic network to access and to query the Main Will-Call Center computer 512. The query allows the Main Will-Call Center computer 512 to identify one or more deliveries that have been ordered, are en route, or have arrived at the Will-Call Center 504 for pickup by the recipient 510. The second frame 604 illustrates a sample display of a listing of the deliveries.

The third frame 606 illustrates a sample display of an interface enabling the recipient 510 to reroute a delivery. The fourth frame 608 illustrates a sample display of an interface that allows the recipient 510 to reroute multiple deliveries to selected destinations and also includes arrival dates associated with the rerouted deliveries. The delivery rerouting system examines a database of Will-Call Centers and identifies the Will-Call Centers in proximity to the selected places that the recipient 510 can access. For example, the accessible Will-Call Centers can include publicly accessible Will-Call Centers and Will-Call Centers at other offices of the recipient's employer. The delivery rerouting system also estimates the expected times/dates of arrival for the deliveries at these alternate Will-Call Centers based on the last known and next expected locations of the deliveries and based on an expected shipping times from these locations. The delivery rerouting system notifies the recipient 510 through the browser 514 of the available pick up options for the deliveries, which can include current locations of the deliveries, expected times/dates when the deliveries could be picked up at the originally-specified Will-Call Center, alternate Will-Call Center sites in proximity to a first location where the recipient prefers to pick up the deliveries, and ranges of expected times/dates when the deliveries are available to be picked up at the alternate Will-Call Centers.

The fifth frame 610 illustrates a sample display that allows a recipient to confirm, on a delivery-by-delivery basis, whether to reroute the deliveries to specified Will-Call Centers by communicating with the delivery rerouting system through the browser interface 514. The delivery rerouting system acknowledges the confirmation and optionally also automatically sends a separate confirmation of the changes to the recipient 510. The recipient can also select not to receive a message. Preferably, the automatic confirmation is an e-mail message sent to the recipient 510. Other examples of messages include, but are not limited to, a text message to a recipient's text pager sent by a unified messaging system and an automatically-generated voice message to the recipient's telephone or voicemail. The delivery rerouting system then automatically notifies and instructs the Will-Call Center attendants, vendors, and shipping companies of the changes, as needed, to reroute the deliveries.

The Will-Call Center rerouting function may further include a feature for permanent rerouting. Permanent rerouting enables a recipient to designate a specific Will-Call Center to accept deliveries, thereby saving the recipient from the task of selecting a Will-Call Center for individual purchases.

FIG. 8 illustrates a distributed process 800 of rapidly and accurately preparing an item for shipping. The process 800 partially automates a shipping event, and can be advantageously used to return items purchased in e-commerce to vendors. The process 800 allows a user to enter shipping information at a convenient time. The process 800 advantageously allows a Will-Call Center to receive the item for shipping in a quick and efficient manner and to retrieve the shipping information accurately and at a convenient time.

In a first step 810, the process receives shipping information from a user and stores the shipping information in a database. The user can, for example, log into a Will-Call Center Web site with a username and a password. The Will-Call Center Web site can be specific to a particular Will-Call Center, or can be a central Web site that hosts information for multiple Will-Call Centers. The shipping information can include information such as the user's information, a shipping address, an order number, an invoice number, a return merchandise authorization (RMA) number, and the like. The user's information may include pre-stored information such as full names, addresses, phone numbers, credit card numbers, and the like. In addition, the user can also input an estimated shipping weight, can specify a particular Will-Call Center location, and can specify a type of shipping, such as ground shipping, next day delivery, second day delivery, and the like. The process advances from the first step 810 to a second step 820.

In the second step 820, the process estimates a shipping charge and verifies an authorization of payment by a credit card company and issues an at least temporarily unique package identifier (id) to the user. The package id can include numerals, characters, and the like. In one embodiment, the credit card is not charged in the second step 820. Of course, where a vendor agrees to pay for shipping, the authorization of payment from the credit card company is not needed. The package id is provided to the user over a Web page or through another medium, such as an email message. Preferably, the user writes or attaches a label with the package id on a box or package that contains the item. The process advances from the second step 820 to a third step 830.

In the third step 830, the process receives the package at a Will-Call Center. The Will-Call Center can identify the package through the package id, and the user can simply drop the package off at a counter without needing to provide additional information. This advantageously reduces the time spent by the user at the counter and allows the Will-Call Center to further prepare the package for shipping when convenient, such as at a later time when the Will-Call Center is less busy. The process advances from the third step 830 to a fourth step 840.

In the fourth step 840, the process prepares the item for shipping. The Will-Call Center references the package by the package id and retrieves the shipping information from the database. The package can also be weighed to re-compute shipping charges as necessary, the results of which are stored in the database. In the fourth step 840, the process also applies a shipping label to the package and stores other shipping information, such as a common carrier's tracking number, into the database. The process advances from the fourth step 840 to a fifth step 850.

In the fifth step 850, the process provides the package to the common carrier for shipping. In one embodiment, the package is scanned and the pick up time is entered into the database. The process advances from the fifth step 850 to an optional sixth step 860.

In the sixth step 860, the process bills the user's credit card for the actual shipping charges. Of course, where the shipping is pre-paid or paid by another entity such as the vendor, the sixth step 860 is not necessary. The process advances from the sixth step 860 to a seventh step 870.

In the seventh step 870, the process automatically provides a notification to the user that the package has been shipped. The notification can be via an email, a Web page, and the like, and can include details such as actual weight, actual shipping charges, and tracking information.

FIG. 9 illustrates one embodiment of a Will-Call Center 900 that provides the physical delivery of goods ordered through an electronic network, such as the Internet. Preferably, the Will-Call Center 900 is located on or near a campus of a relatively large organization, such as a workplace or a university. More preferably, the Will-Call Center 900 is located near a relatively high traffic area such as adjacent to a cafeteria.

A recipient of a good is provided with access to a public area 902. In the public area 902, the recipient can access a computer terminal 904, which can be used to order items, to check the status of ordered items, to enter information for returns, to arrange for rerouting, to enter keys and/or passwords to unlock electronically locked boxes, and the like.

One embodiment of the Will-Call Center 900 includes electronically locked boxes 905. The electronically locked boxes 905 allow the recipient to pick up a delivery without interaction with an attendant associated with the Will-Call Center 900. Preferably, the electronically locked boxes 905 include a transparent, semi-transparent, or translucent panel that allows the recipient to quickly identify whether a box contains a delivery or not. The panel can also be made from other materials such as a screen or a mesh. In one embodiment, at least some of the electronically locked boxes 905 include refrigeration for perishable goods.

The Will-Call Center 900 further includes a customer counter area 906 with a point of sale terminal 908. The attendant can provide the recipient with the delivery at the customer counter area 906. The point of sale terminal 908 allows the attendant to identify a customer, to determine which deliveries are awaiting pickup by the customer, to identify where a delivery is stored, to collect fees for purchases, shipments, storage, and the like. In addition to the public area 902, the attendant of the Will-Call Center 900 can also access storage areas and receiving areas through access doors 910, 912. The storage areas can include storage for relatively large or bulky items and can include refrigerated storage for perishables. Preferably, at least a portion of the deliveries stored is maintained in a viewable storage area 914. Items stored in the viewable storage area can be observed from the public area. Items in the viewable storage area 914 are maintained behind a wall of a transparent, semi-transparent, or translucent material such as a clear plastic, glass, frosted glass, and the like. In one embodiment, the wall is a screen or a mesh.

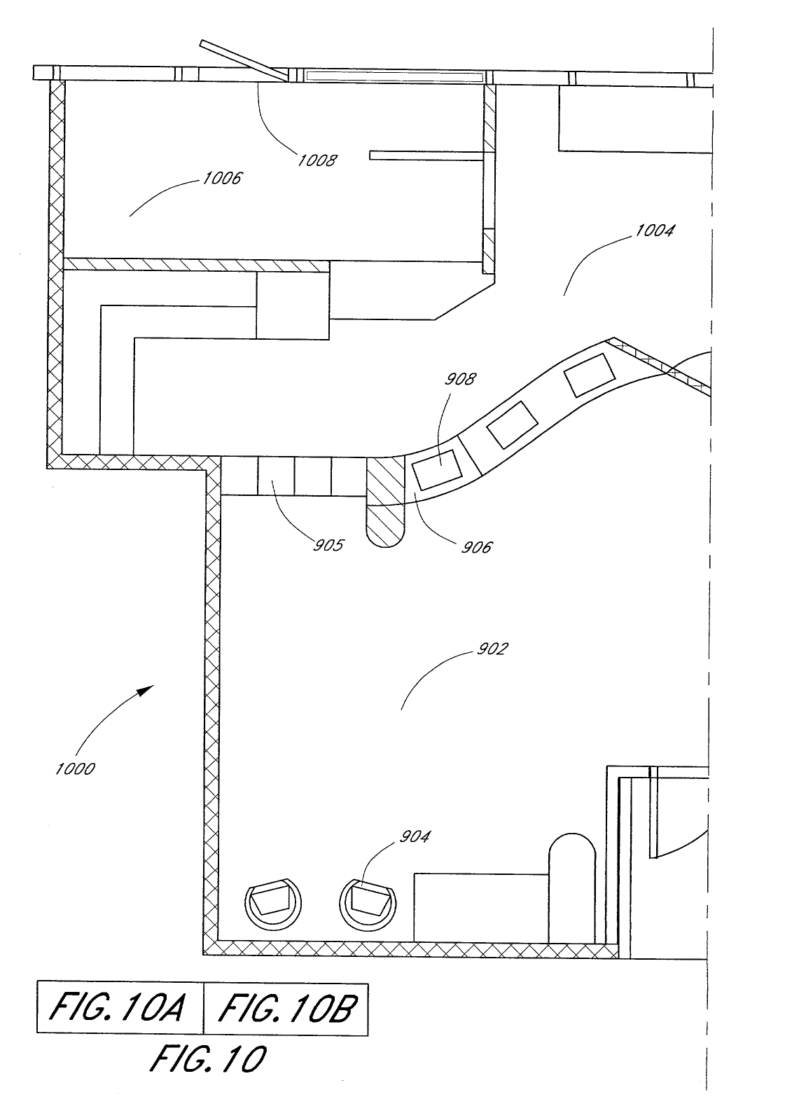

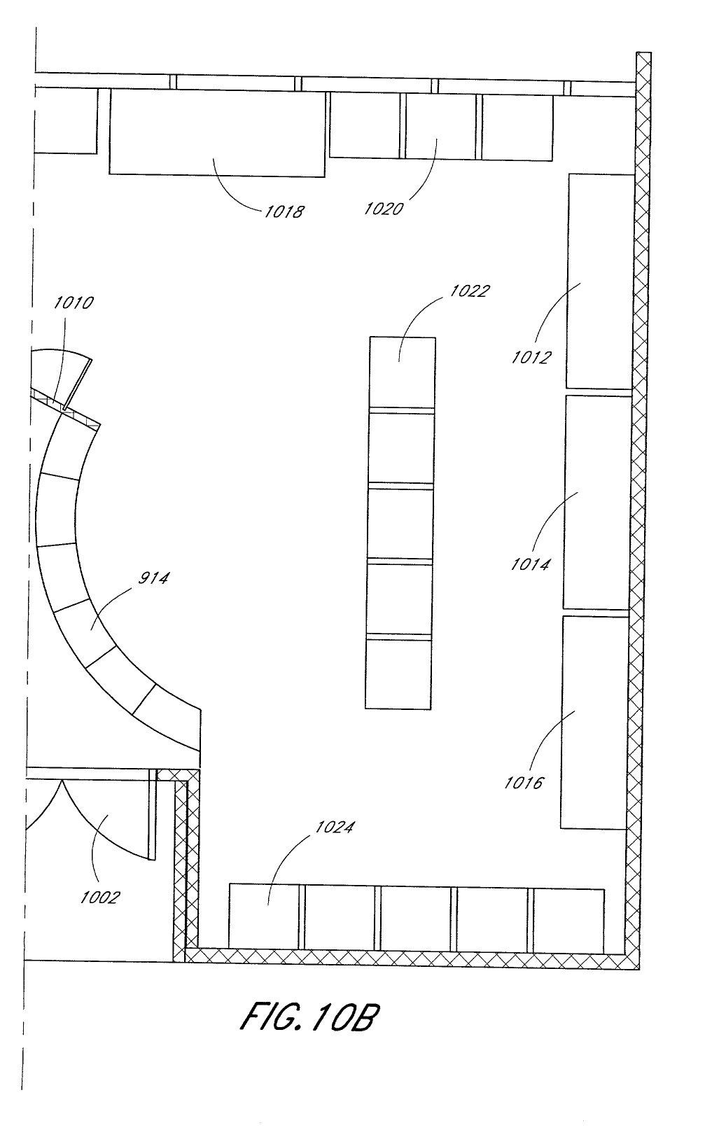

FIG. 10 illustrates a top view of a layout of another embodiment of a Will-Call Center 1000. Customers, including buyers and/or recipients, enter the Will-Call Center 1000 through a main entrance 1002. The main entrance 1002 provides access to the public area 902. In the public area 902, a customer can access the computer terminal 904, can receive a delivery from a box in the electronically locked boxes 905, and can receive a delivery from the customer counter area 906.

The attendant can access personnel areas 1004, 1006, which are used to receive, to store, and to process deliveries. A loading door 1008 provides access for deliveries from shipping companies such as common carriers. An access door 1010 separates the public area 902 from the personnel area 1004. Preferably, a portion of the deliveries is stored in the viewable storage area 914. In addition, the storage facilities can include refrigerated storage areas 1012, 1014, 1016, storage areas that are freezers 1018, as well as other storage areas 1020, 1022, 1024.

A Will-Call Center system may optionally feature incentives. Incentives may be offered by a vendor, by a Will-Call Center, or by both. In one embodiment, the vendor offers pricing incentives such as discounts, rebates, and gifts based on a selection of delivery to a Will-Call Center. The discounts and rebates may be applicable instantly or applied to future purposes. The gifts may be included in the shipment with the delivery, delivered at a later date, or include an item already stored at the Will-Call Center. If the gift is an item already stored at the Will-Call Center, upon notification from a vendor, the Will-Call Center system then allocates the gift and includes the gift among the list of deliveries awaiting pickup by the recipient.

A database communicating with the vendor's system may indicate the presence and the type of incentive, which may then be relayed by the vendor's system to a buyer. The incentive may be tied to service costs offered by a Will-Call Center. A Will-Call Center may further subsidize the incentive, for example, as part of a grand opening promotion. In addition, as a service to vendors and buyers, the Will-Call Center can also provide printed vendor catalogs to prospective buyers. Some buyers prefer to browse through a vendor's catalog in a printed format. Allowing prospective buyers to pick up a catalog can advantageously lower catalog distribution costs over mass mailings.

The Will-Call System may save buyer specific data, such as, but not limited to, demographic data, psychographic data directly or indirectly derived from the buyer, product, service, or vendor preferences, etc. This data may be used to improve the buying experience of the buyer or to allow the Will-Call Center system to automatically promote or advertise certain products, services, or vendors to the buyer before, during or after the buyer's purchase transaction. The Will-Call Center may transmit this data to other parties, such as vendors, buyers, marketing firms, consumer database firms, and the like.

A Will-Call Center may further feature automated product and vendor selection. The Will-Call Center system may advantageously relate pricing and shipping costs for the same or similar products. In one embodiment, the Will-Call Center Web site allows a buyer to select items into a shopping cart. The Will-Call Center Web site allows the buyer to select purchases from a vendor or multiple vendors. Before placing orders with the actual vendors, the Will-Call Center's order consolidation and cost optimization system analyzes the contents of the shopping cart and computes costs from different vendors for the same or similar items. In one embodiment, the Will-Call Center Web site operates seamlessly and the buyer is unaware that the Will-Call Center undertakes an intermediate step of order consolidation and cost optimization prior to placing the orders. One version of the order consolidation and cost optimization system relates the same or similar products in a database. Another version invokes a real time search.

Vendors vary in price, current availability shipping rates, handling fees, etc. The order consolidation and cost optimization system compares various pricing among the vendors accessible in the database. An exemplary sequence of events occurs as follows: (1) the Will-Call Center's order consolidation and cost optimization system evaluates various combinations of consolidated orders that are possible for delivery to the recipient(s). In an example with a single recipient, if product A is available at vendors 1 and 2, while product B is available only at vendor 1 only, and product C is available at vendors 1 and 3, the various combinations of consolidated orders is as follows: (a) all 3 products from vendor 1; (b) product A from vendor 2, products B and C from vendor 1; (c) product A from vendor 2, product B from vendor 1, product C from vendor 3, and (d) products A and B from vendor 1, product C from vendor 3. (2) The Will-Call Center's order consolidation and cost optimization system determines a total cost of the possible combinations of consolidated orders, including the cost of the product from the vendor, sales taxes, and shipping and handling costs, etc. (3) The Will-Call Center's order consolidation and cost optimization system identifies the lowest-cost option. (4) If the lowest-cost option differs from the order as originally entered by the buyer, the Will-Call Center's order consolidation and cost optimization system presents the lowest-cost option as an alternative to the buyer and may additionally present other purchase combinations. (5) The Will-Call Center's order consolidation and cost optimization system enables the buyer to elect the lowest-cost option or another purchase combination, including the order as originally entered by the buyer, and the order consolidation and cost optimization system completes the purchases automatically as appropriate.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method of providing an item for pickup that has been ordered from an online merchant by a user operating a remote client computer, the method comprising:
receiving an order for the item in a merchant computer system, where the order is received from a first electronic message from the remote client computer, wherein the order designates a Will-Call Center selected from a plurality of predetermined Will-Call Centers, where the Will-Call Center is a separate entity from the online merchant;
locating a distribution center carrying the item;
packaging the item in a package such that the package includes a machine-readable reference to an identifier of the package, where the identifier is related to the user in a database;
sending a second electronic message to a remote common carrier computer system to request a common carrier associated with the remote common carrier computer system to ship the item from the distribution center to the Will-Call Center;
sending a third electronic message to a Will-Call Center computer system such that the Will-Call Center computer system can identify the package when the package arrives;
shipping the item from the distribution center to the Will-Call Center;
scanning the machine readable reference on the package at the Will-Call Center with a scanning device, which is at least periodically coupled to the Will-Call Center computer system to transfer the identifier to the Will-Call Center computer system; and
automatically sending a fourth electronic message to a recipient after receiving the identifier and relating the package to the recipient.

2. The method as defined in claim 1, wherein the recipient is the user.

3. The method as defined in claim 1, wherein the Will-Call Center computer system is located within a network firewall associated with a client computer of the user, and where the fourth electronic message is an email message carried within an Intranet associated with the network firewall.

4. The method as defined in claim 1, further comprising automatically identifying the recipient in response to a scanning of a barcode associated with the recipient.

5. The method as defined in claim 1, wherein the fourth electronic message includes a hyperlink to an interactive Web page with information relating to the package, further comprising:
providing the recipient with a location of the originally selected Will-Call Center and an estimate of when the package is expected to be available;
receiving an entry from a Web browser of the recipient, where the entry includes a designation for a different Will-Call Center;
sending a fifth electronic message to the remote common carrier computer system to cancel shipment to the originally selected Will-Call Center;
sending a sixth electronic message to the different Will-Call Center computer system such that the different Will-Call Center computer system can identify the package when the package arrives; and
shipping the item from the distribution center to the different Will-Call Center.

6. The method as defined in claim 1, further comprising:
embedding the machine readable reference in a barcode label, where the barcode label is related to at least one record in a database identifying the contents of the package; and
applying the barcode label to the package.

7. The method as defined in claim 1, wherein the machine-readable reference is a label used by the common carrier to identify the package.

8. The method as defined in claim 1, further comprising:
providing the Will-Call Center computer system with an indication of a size of the package before the package is delivered to the Will-Call Center by the common carrier;
retrieving indications of sizes of physical spaces in the Will-Call Center;
evaluating a size of at least one physical space within the Will-Call Center relative to the indication of the size of the package;
automatically allocating the physical space for a time period that includes at least a delivery time to the Will-Call Center when the physical space is large enough to store the package; and
automatically de-allocating the physical space in response to a pickup of the package.

9. The method as defined in claim 1, further comprising:
providing the Will-Call Center computer system with an indication of a size of the package and a refrigeration requirement associated with the item before the package is delivered to the Will-Call Center by the common carrier;
retrieving descriptions of storage spaces in the Will-Call Center, where the descriptions include a size and a refrigeration characteristic associated with the storage space;
evaluating the size and the refrigeration characteristic of at least one physical space within the Will-Call Center relative to the received indication of the size of the package and the refrigeration requirement associated with the item;
automatically allocating a physical space for at least a delivery time to the Will-Call Center when the physical space is large enough to store the package and the physical space is compatible with the refrigeration requirement; and
automatically de-allocating the physical space in response to a pickup of the package.

10. The method as defined in claim 1, further comprising:
providing the Will-Call Center computer system associated with the selected Will-Call Center with at least one physical characteristic of the package and an expected arrival date of the package prior to shipping the package to the selected Will-Call Center;
receiving an indication from the selected Will-Call Center computer system as to whether the selected Will-Call Center has at least one available appropriate physical space available to store the package on at least the expected arrival date;
automatically reserving an available appropriate physical space on at least the expected arrival date in the selected Will-Call Center when the indication provides that the selected Will-Call Center has at least one available appropriate physical space; and
selecting a new Will-Call Center when the indication indicates provides that the previously selected Will-Call Center does not have at least one available appropriate physical space to store the package.

11. The method as defined in claim 1, further comprising:
providing the Will-Call Center computer system associated with the selected Will-Call Center with at least one physical characteristic of the package and an expected arrival date of the package prior to shipping the package to the selected Will-Call Center;
receiving an indication from the selected Will-Call Center computer system as to whether the selected Will-Call Center has at least one available appropriate physical space available to store the package on at least the expected arrival date;
automatically reserving an available appropriate physical space on at least the expected arrival date in the selected Will-Call Center when the indication provides that the selected Will-Call Center has at least one available appropriate physical space; and
changing a characteristic of the shipping from the distribution center to the Will-Call Center such that the package is scheduled to arrive at the selected Will-Call Center on a new expected arrival date.

12. The method as defined in claim 1, further comprising automatically selecting the Will-Call Center from the plurality of predetermined Will-Call Centers in response to a received ZIP code.

13. A method of making available an item ordered in e-commerce, the method comprising:
providing a buyer with an electronic catalog that is viewable through a Web browser;
receiving a selection from the Web browser of at least one item for purchase;
receiving a designation from the Web browser of a Will-Call Center where the item is to be picked up;
shipping the item to the designated Will-Call Center;
automatically receiving an indication from the Will-Call Center in response to an arrival of the shipped item; and
automatically receiving an indication from the Will-Call Center when the shipped item has been picked up.

14. The method as defined in claim 13, further comprising automatically notifying the designated Will-Call Center of an impending delivery of the item.

15. The method as defined in claim 14, further comprising:
providing a Web page that includes information relating a location of the originally selected Will-Call Center and an estimate of when the package is expected to be available at the originally selected Will-Call Center in response to a query from the Web browser;
receiving an entry from a Web browser that designates a new Will-Call Center;
intervening the shipping of the item to the originally selected Will-Call Center;
automatically notifying the originally selected Will-Call Center of the cancellation of the delivery of the item to the originally selected Will-Call Center;
automatically notifying the new Will-Call Center of a new impending delivery of the item;
automatically receiving an indication from the new Will-Call Center in response to an arrival of the shipped item; and
automatically receiving an indication from the new Will-Call Center when the shipped item has been picked up.

16. The method as defined in claim 13, further comprising:
receiving a first payment from the buyer;
providing a second payment to a shipper; and
providing a third payment to the Will-Call Center.

17. The method as defined in claim 13, further comprising:
selecting a first group of Will-Call Centers from a plurality of Will-Call Centers, where the first group includes Will-Call Centers in a first vicinity of at least a portion of an address received from the Web browser;
displaying the first group of Will-Call Centers through the Web browser; and
receiving the designation from the Web browser of the Will-Call Center through a selection of a Will-Call Center in the first group.

18. The method as defined in claim 13, wherein a plurality of items is ordered, the method further comprising:
creating multiple combinations of items and vendors, where a combination from the multiple combinations includes a of items ordered;
summing cost for the combinations, where the costs include prices for the items from the vendors, shipping costs from a common carrier for shipping the items from the vendors to the Will-Call Center, and sales taxes, where applicable;
displaying the combinations through the Web browser;
receiving a selection of a combination from the multiple combinations; and
placing orders for the items and the vendors corresponding to the selected combination with shipping to the Will-Call Center.

19. The method as defined in claim 18, further comprising arranging the combinations for display in order of cost.

20. The method as defined in claim 13, wherein the Will-Call Center is physically located in a campus of an entity selected from the group consisting of a university, a large apartment complex, a hospital, and a corporation.

21. A method of providing an item ordered in e-commerce to a recipient, the method comprising:
receiving a package from a common carrier that contains an item ordered in e-commerce;
scanning an identifier included with the package;
relating the identifier to a recipient of the package;
automatically informing the recipient after arrival of the package;
storing and locking the package in an electronically lockable box that is accessible to the recipient;
storing an electronic key in a database, where the electronic key can unlock the lockable box;
receiving a code from the recipient;
comparing the code to the key; and
unlocking the box in response to a match between the code and the key.

22. The method as defined in claim 21, wherein the code is received from a keypad.

23. The method as defined in claim 21, further comprising:
relating the electronic key in the database to a barcode maintained by the recipient; and
scanning the barcode to receive the code from the recipient.

24. The method as defined in claim 21, further comprising automatically providing an indication of a physical size of the package to the recipient.

25. A method of preparing an item originally purchased in e-commerce for return to a vendor, the method comprising:
providing a Web page to a remote user with a browser in a network, wherein the Web page includes a fillable form;
receiving shipping information from the browser, wherein the shipping information includes information relating to the user and a shipping destination for the item from the browser;
storing the shipping information in a database;
providing an at least temporarily unique id to the browser;
storing and relating the unique id to the shipping information in the database;
accepting the item for return to the shipping destination upon receiving the item and receiving the unique id without needing additional information;
automatically printing a shipping label for a common carrier from the shipping information in the database that is related to the unique id; and
providing an automatic notification of a pickup of the item by the common carrier.

26. The method as defined in claim 25, further comprising:
inspecting a physical condition of the item; and
automatically sending a report of the physical condition to the vendor.

27. A system that provides an item for pickup that has been ordered from an online merchant by a user operating a remote client computer, the system comprising:
means for receiving an order in a merchant computer system for the item in a first electronic message from the remote client computer, wherein the order designates a Will-Call Center selected from a plurality of predetermined Will-Call Centers;
means for locating a distribution center carrying the item;
means for packaging the item in a package such that the package includes a machine-readable reference to an identifier of the package, where the identifier is related to the user in a database;
means for sending a second electronic message to a remote common carrier computer system to request a common carrier associated with the remote common carrier computer system to ship the item from the distribution center to the Will-Call Center;
means for sending a third electronic message to a Will-Call Center computer system such that the Will-Call Center computer system can identify the package when the package arrives;
means for shipping the item from the distribution center to the Will-Call Center;
means for scanning the machine readable reference on the package at the Will-Call Center with a scanning device, which is at least periodically coupled to the Will-Call Center computer system to transfer the identifier to the Will-Call Center computer system; and
means for automatically sending a fourth electronic message to a recipient after receiving the identifier and relating the package to the recipient.

28. An electronically lockable storage box that allows a user to pick up an item ordered in e-commerce comprising:
an interior adapted to hold a package;
an exterior, at least a portion of which is accessible to a user;
a movable access panel that forms at least a part of the portion of the exterior, wherein the movable access panel is adapted to prevent access to the interior in a first position and to allow access to the interior in a second position;
an interface to a computer network that is adapted to receive an unlocking key related to the package from a remote computer system;
a data input device in communication with the computer network, where the data input device is adapted to receive an entered key from the user; and
a locking mechanism adapted to maintain the movable access panel in the first position when the locking mechanism is locked and to permit the movable access panel to achieve the second position when the locking mechanism is unlocked, wherein the locking mechanism unlocks in response to a condition of the entered key corresponding to the unlocking key at a time when the package resides in the interior of the electronically lockable storage box.

29. The electronically lockable storage box as defined in claim 28, wherein the interface and the storage unit reside in a central computer system in communication with a plurality of electronically lockable storage boxes.

30. The electronically lockable storage box as defined in claim 28, wherein the movable access panel includes a sliding drawer.

31. The electronically lockable storage box as defined in claim 28, wherein the data input device is a keypad.

32. The electronically lockable storage box as defined in claim 28, wherein the data input device is a barcode scanner.
